(19) United States
(12) Patent Application Publication
(10) Pub. No.: US 2026/0221420 A1
(43) Pub. Date: Jul. 30, 2026

(54) ZINC ELECTRODE

(71) Applicant: ZN2H2 Inc., King Prussia, PA (US)

(72) Inventors: Oren ROSENFELD, Raanana (IL); Chaim MARKHEIM, Ramat-Gan (IL); Andreas SCHAMEL, Erftstadt (DE)

(21) Appl. No.: 19/137,813

(22) PCT Filed: Dec. 13, 2023
(86) PCT No.: PCT/US2023/083761

§ 371 Date: Jun. 11, 2025

Related U.S. Application Data
(63) Continuation-in-part of application No. PCT/US2023/066222, filed on Apr. 26, 2023.

(30) Foreign Application Priority Data
Dec. 14, 2022 (EP) 22213375.3

(51) Int. Cl. H01M 4/24; H01M 4/02; H01M 4/04; H01M 4/66; H01M 4/70

(52) U.S. Cl. CPC H01M 4/244; H01M 4/0404; H01M 4/661; H01M 4/667; H01M 4/70; H01M 2004/021

(57) ABSTRACT

The present invention relates to a zinc electrode (100) on which a solid metallic zinc layer (300) is electrodeposited, an electrochemical cell and a method for zinc electrodeposition in the electrochemical cell. According to the invention, a zinc electrode (100) is provided, wherein the zinc electrode (100) comprises a current collector material (200) on which a zinc layer (300) is electrodeposited, wherein the zinc layer (300) appears as compact solid metal, comprises a boulder-like and/or layerlike microstructure, and is adherent with a compact porosity.

### CROSS-REFERENCE TO RELATED APPLICATIONS

This is the U.S. national stage of International Patent Application No. PCT/US2023/083761, filed on Dec. 13, 2023, claiming priority to European Patent Application No. 22213375.3, filed on Dec. 13, 2022 (also referred to as EP 22213375), and also claiming priority to International Patent Application No. PCT/US2023/066222, filed on Apr. 26, 2023.

### FIELD

The present invention relates to a zinc electrode on which a solid metallic zinc layer is electrodeposited, an electrochemical cell and a method for zinc electrodeposition in the electrochemical cell.

### BACKGROUND

Zinc (Zn) electrodes or the electrodeposition of zinc on a collector material is important for many aspects, for example electrowinning, electrogalvanizing, zinc rechargeable batteries and many more.

### SUMMARY

Zinc is one of the most used negative electrode material of batteries due to its high-capacity density of 820 Ah/kg (equal approx. 5820 Ah/l). Except for the zinc-carbon primary battery, in which zinc anode is in solid form, the zinc electrode in all battery systems is powdery to achieve high zinc electrolyte interface and good availability of electrolyte near the surface. Such electrodes have space for storing dissolution products and allow a high reaction rate due to high surface area on both weight and volume basis.

In zinc electrodes of different battery systems, a porosity of 60-80% of zinc deposits is most commonly found. This is equivalent to a capacity of 1.2 Ah/cm³ (equals ~1.46 g/cm³) to 2.2 Ah/cm³ (equals ~2.7 g/cm³) for the zinc active material in such applications.

However, high energy density alkaline primary batteries use higher density of the Zn electrode of 3-3.5 g/cm³, that corresponds to approx. 42-50% zinc volume or approx. 50-58% porosity of these zinc deposits.

The standard potential of the zinc electrode is shown in equation [I].

$$Zn ⇄ {Zn}^{2 +} + 2 {e}^{-} {E}^{0} = - 0.763 V \qquad [ I ]$$

The oxidation of zinc electrode during discharge may involve several basic steps, which include oxidation of zinc atoms on the surface (i.e. the breaking up of the metallic bonding), solvation in the solution, diffusion in the electrolyte, and precipitation of the solid phase of zinc oxide (ZnO) when the solubility limit is reached. The reverse is involved in the deposition process during (re) charging of the electrode.

A number of zinc complexes may form but the predominant species in high molar potassium hydroxide (KOH) has been identified as the tetrahedral

$${Zn ( OH )}_{4}^{2 -}$$

-complex. The electrode also has a rather high exchange current density, on the order of 0.1-0.25 A/cm².

The dissolution process at a zinc electrode in alkaline solutions can be expressed in equation [II].

$$Zn + 4 {OH}^{-} = {Zn ( OH )}_{4}^{2 -} + 2 {e}^{-} \qquad [ II ]$$

When the solution near the surface becomes saturated with the dissolved zinc species, precipitation of zinc oxide may occur according to the following reaction [III].

$${Zn ( OH )}_{4}^{2 -} = ZnO + 2 {OH}^{-} + {H}_{2} O \qquad [ III ]$$

Thus, the overall reaction from zinc metal is depicted in equation [IV].

$$Zn + 2 {OH}^{-} = ZnO + {H}_{2} O + 2 {e}^{-} \qquad [ IV ]$$

However, the morphology of the zinc deposits and their control play a crucial role in the quality and performance of the final zinc-deposited electrodes and in the use of such electrodes in various applications.

So far, zinc electrodes are mostly used for primary, not rechargeable batteries like alkaline or Zn-air batteries. Rechargeable systems that use a negative zinc electrode had been investigated and developed for a variety of applications like Zn—Ag batteries, Zn—MnO₂ rechargeable alkaline batteries, Zn—NiOOH rechargeable nickel zinc batteries, Zn—O₂ rechargeable zinc air batteries, Zn—H₂ hydrogen generation cells or electrolyzers that produce sequentially hydrogen and oxygen and store the energy in between by the deposition of zinc.

However, zinc batteries use high surface area zinc electrodes (anodes) to reduce over-potential. The high surface area is achieved by using small particle powder zinc paste also named powdery zinc. Zinc electrodes for the use in rechargeable batteries must possess some kind of grid, lattice-like structure to fix the Zn-ions to their place. This fixation is primarily ensured by additives and binders. The advantage of powdery zinc is in its slightly lower over-potential while discharging. Normally, zinc in the form of powder, granular compositions or fibers are used in gel form with binder and additives as negative electrode in zinc batteries, whereby the typical zinc particle sizes are in the range between 20 and 50 μm.

A significant problem associated with zinc-based rechargeable batteries is the limited cycle-life principally due to the zinc electrode's morphology of which tends to change on electrodeposition of the zinc during charge or the whole cycling. The change of morphology that causes an electrode to decline in performance or fail can be in several modes: shape change, deposition of mossy zinc, densification, and dendrite formation. Shape change is a phenomenon involved with alteration of the zinc electrode geometric area, where zinc active material leaves one location and agglomerates in other locations. In such batteries not all zinc ions are actually fixed to their place, flow around in the electrolyte and will be deposited back as metallic zinc in a different location. Densification is the phenomenon wherein the electrode loses porosity and active surface area and thereby suffers a reduction in its kinetic capability and passivates easily. Densification is often observed together with shape change. Dendrite formation occurs during the charging period and may result in penetration through a separator of an electrochemical cell causing shorting and instant cell failure.

The interest in developing rechargeable zinc batteries or zinc air batteries as a high-energy power source has stimulated sustained research on deposition from alkaline zincate solutions. The cycle life of such rechargeable zinc or zinc-air batteries has been found to be limited mainly because the zinc electrode is the life-limiting factor due to its tendency to passivation and solubility in a concentrated alkaline solution. Further, morphological changes during charging or discharging of the zinc electrode can occur like dendritic formation or loss of porosity. Another point to consider is the potential for mossy and heavy sponge formations, which can cause zinc particles to detach from the electrode and cause short circuits in a cell.

Morphological zinc deposits that can occur during the electrodeposition of zinc to produce a zinc-deposited electrode comprise various types. Usually, five main morphology types are described in the state of the art. These types are heavy spongy, dendritic, boulder, layerlike and mossy. It is generally assumed that the growth of dendrites is under diffusion control, whereas that of mossy is under activation control. Kinetically, there are preferred crystal directions and planes for dendrite growth. The two morphology types, mossy and dendrite, must be prevented in battery applications. Mossy deposits may lead to loss of active material or short circuit at the electrode edges. It can also result in shape change. Mossy zinc is preferably deposited at low current density, high zincate concentration and high temperature. Conditions that favor the formation of dendrites are high current density, low zincate concentration and low temperature. It also had been shown that molecular hydrogen (H₂) generation can lead to morphology shape change in favor of dendritic, mossy or heavy spongy morphologies. Further, H₂ evolution leads to electrolyte dry out and pressure buildup in an electrochemical cell. H₂ generation is the result of too high current densities and therefore overvoltage during the charging.

The causes why and under which conditions one or the other morphological feature occurs are subject of current research and not yet fully elucidated. How such structures can be almost completely prevented during the production of a zinc-loaded electrode is not yet understood. Structures such as those described as boulder or layerlike can only be produced under very specific conditions and starting materials. For example, in the prior art, such structures could only be produced by electrodeposition of zinc on a zinc substrate. However, this makes such products unusable for applications in a galvanic cell or even a battery.

Wang et al. describe morphological variations of zinc deposits form alkaline solutions and characterize and categorize the morphological features of zinc deposits (R. Y. Wang et al. “Effects of Deposition Conditions on the Morphology of Zinc Deposits from Alkaline Zincate Solutions”, J. Electrochem. Soc, 2006, page 405).

Chladil et al. describe the influence of charging/depositions mode on the resulting morphology of zinc deposit over the wide range of deposition frequencies, wherein all depositions were performed in the mostly use 6 M KOH saturated by zinc oxide. The deposited layers were evaluated from their morphology point of view and the electrochemical behavior of deposit in relation to their dissolution reaction was investigated by linear polarization and electrochemical impedance spectroscopy (EIS) methods (Chladil Ladislav et al.: “Pulse Deposition of Zinc in Alkaline Electrolytes for Ni—Zn Secondary Batteries”, ECT Transactions, vol. 63, no. 1, 17 Jul. 2014, pp 217-223).

Zelger et al. describe the effect of pulse interrupt current on the morphology of electrodeposited zinc in non-stagnant alkaline electrolytes with the Rota-Hull cell. According to said paper the pulse interrupt current Rota-Hull cell experiments produce compact zinc deposits at all electrolyte flow velocities an zincate concentration (Zelger Christian et al.: “Rota-Hull Cell Study on Pulse Current Zinc Electrodeposition from Alkaline Electrolytes”, Electrochimica Acta, Elsevier, Amsterdam, NL, vol. 213, 21 Jul. 2016, pp 208-2016).

Pichler et al. describe the influence of different operating conditions both on the long-term performance of bifunctional air electrodes as well as on the growth morphology of zinc on several current collector materials. Moreover, the recharge capacity of the zinc electrode was studied with pulse interrupt currents (PIC) on rotating electrodes in order to achieve dendrite-free zinc deposits (Pichler Birgit et al.: “The impact of operating conditions on component and electrode development for zinc-air flow batteries”, Journal of Applied Electrochemistry, Springer, Dordrecht, NL, vol. 48, no. 9, 7 Jul. 2018, pp 1043-1056)

Han et al. describe the mechanism and the state-of-the-art progress on zinc electrode protection in full pH range aqueous electrolytes (Han Chao et al.: “Principals and strategies for constructing a highly reversible zinc metal anode in aqueous batteries”, Nano Energy, vol. 74, 7 Jul. 2020, p 104880).

However, the prior art methods cannot produce a uniform zinc layer over a longer deposition time, not to mention a zinc layer of greater mass. In the methods known from the prior art, a morphology change of the zinc layer always occurs with longer electrodeposition. During electrodeposition according to the state of the art, the zinc layer undergoes morphology changes from a rather compact and adherent layer to a mossy- or heavy spongy, non-compact, highly porous or filamentous layer, which is no longer adherent and thus, can lead to short circuits or other effects like overheating. In other cases, a formation of a dendritic layer leads to the stop or interruption of the electrodeposition process. Dendrites will also result in short circuit. In addition, passivation, which may have occurred during a previous discharge, leads to the formation of mossy or filamentous deposits during a new deposition process. Such filamentous deposits have a low density and do not adhere to the electrode, which leads to short circuits.

Furthermore, rechargeable batteries or electrochemical storage with a zinc minus pole can be constructed in the charged state with a metallic zinc electrode or in the discharged state with ZnO layer on the current collector or zincate in the electrolyte. Primary batteries—of course—are fabricated in the charged state with zinc powder. Rechargeable NiZn batteries are in most cases assembled in the discharged state but also in the charged state—for example with a 3D porous zinc electrode.

State of the art zinc electrodes differ from their structure and the amount of zinc. For rechargeable systems the capacity density is related to the depth of discharge (DOD) or the state of charge (SOC) that can be used during cycling. That means, not all of the zinc is utilized for energy storage. In primary systems, approximately 95% of the zinc is used for discharge. But, state of the art rechargeable systems would only survive a couple of cycles, approximately 10 cycles, with DOD/SOC in the range of 90%. The best reported results show 100-200 cycles with DOD 40% and several thousand cycles at DOD <1%.

In most cases of Zn-air and NiZn rechargeable batteries, the zinc electrode, not the counter electrode, is the life (cycle number) limiting component. The reason for not full cycling of the zinc is that the zinc electrode loses its structure and electrical interconnections between the active material parts. In most systems, the zinc electrode has two to three times higher capacity than the counter electrode. It should be noted that due to the high capacity of the zinc metal, even 30-40% zinc utilization for cycling results in competitive battery systems.

Therefore, embodiments of the present invention can be based on the object to provide an electrodeposited zinc electrode which overcomes the disadvantages in the state of the art. For example, some embodiments can be configured to provide a zinc electrode which is capable of performing nearly 100% zinc utilization while providing almost infinity cycles when used in an application.

A zinc electrode is provided, wherein the zinc electrode comprises a current collector material on which a zinc layer is electrodeposited, wherein the zinc layer appears as compact solid metal, comprises a boulder-like and/or layerlike microstructure, and is adherent with a compact porosity. In the sense of the invention compact means densely packed, without large gaps.

According to yet another preferred embodiment, the zinc layer is partially or completely removed from the current collector material during a discharge cycle resulting in a bare current collector material in case of a complete removal.

In the sense of the invention completely means that approximately 100% of the zinc layer can be removed. In other words, it is possible to dissolve the zinc layer partially (SOC >0) or completely (SOC=0) from the current collector material by a discharge process, so that a bare current collector material is available for a further electrodeposition in case of a complete dissolution of the Zn layer. However, the discharge can also dissolve the Zn layer only partially and the Zn layer can then be electrodeposited again. In principle, this formation/electrodepositing and dissolution of the Zn layer can be repeated almost infinitely. In the sense of the invention a bare current collector material means a current collector material in its originally used initial state i.e., without or almost without any residues on it.

According to yet another preferred embodiment, the zinc layer is electrodeposited on a bare current collector material or on a current collector material on which a zinc layer is already electrodeposited. This means the electrodeposition of the electrode according to the invention can start or take place at SOC ≥0.

According to yet another preferred embodiment, the zinc layer comprises a density of 3.50 to 7.14 g/cm³. A density in the range of 4.50 to 7.14 g/cm³ is preferred, and a density in the range of 5.00 to 7.00 g/cm³ is particularly preferred. In the ideal case, the density is near 7.14 g/cm³. These densities are almost identical to the real densities of metallic zinc. This shows that the zinc deposit according to the invention is almost identical to that of the real density of metallic zinc. Mossy or dendritic zinc deposits do not achieve such densities. In a few experiments, zinc deposits with a higher density could be produced from the state of the art, but they had a very low thickness and were partly subject to morphological changes. Furthermore, in these tests, zinc deposits were only deposited on a toughened zinc substrate as a collector material, which does not make sense for a commercial application. A certain low porosity that results in a density less than 3.5 g/cm³ or lower can be achieved at certain deposition conditions. That may be favorable to achieve a higher surface area and thus lower overpotential.

The zinc electrode maintains the high-capacity density of the zinc. The deposited density of 3.50-7.14 g/cm³ according to the invention corresponds to a capacity density of 2.87 Ah/cm³-5.85 Ah/cm³ respectively. Such a zinc electrode according to the invention, when used in a battery or other application, can provide almost infinite charge/discharge cycles of the battery or other application. The zinc deposition according to the invention results in a compact, interconnected metal morphology. There is a direct electrical connection of all parts of the zinc deposit to the current collector material. Thus, there are no oxide barriers as with powder/particle zinc electrode applications. A feature of the invention is that with such a zinc electrode, when used in a cell system or application such as a battery, such a system or application starts in a discharged state SOC=0. By using the zinc electrode according to the invention, much higher energy density can be achieved in applications due to the use of a high SOC (up to about 80-100% of the ZnO/zincate of the system/application can be used for charging and 100% DOD can be used for discharging). It is one of the features of the invention that large numbers of cycles (virtually infinite cycles) can be achieved by introducing 100% DOD steps during the cycling process when the zinc electrode is used, for example, in a battery. Zinc volume changes and/or partial mossy/dendritic deposits can be completely removed and the system, more precisely the zinc electrode can start again with a homogeneous and smooth zinc deposition. The capacity and capacity density values described in the present invention therefore relate to 100% DOD—the full utilization of the deposited zinc for energy storage and therefore high capacity density.

According to a preferred embodiment, neither the current collector material nor the zinc layer comprises a binder, a grid, a foam, a fabric structure, or an additive to couple the zinc layer to the current collector material. Unlike in the prior art, the electrode according to the invention does not require any grid, foam or fabric structures or binders, as is the case with rechargeable Zn-air or primary batteries hence the electrode according to the invention has much higher energy density compared to the prior art. Further, the inventive electrode is not comprising additives such as calcium hydroxide that is usually present for immobilization of zincate.

According to another preferred embodiment, the zinc layer is made from non-powder zinc. Compared to powdered zinc electrodes and their applications, however, the active surface of the electrode according to the invention is smaller and thus the overvoltage is greater. In the solid non-powdery zinc deposition according to the invention, there will always be electrical connection of the zinc with the current collector material, whereas in powdery deposition the passivated particle will lose its electric connection with the current collector, hence causing lower utilization of active material. Here, it is important to understand that in the electrode according to the invention, during charging or electrodeposition pure solid metal zinc is plated, powdery deposits are not produced nor are they already present. Powdery zinc is also understood to be a deposit of mossy zinc, which has the same negative properties as powdery zinc when it is detached from the substrate. However, such a powdery deposition is not desired in the electrode according to the invention, quite the contrary, because the zinc deposition according to the invention leads to a compact, interconnected metal morphology. Although the surface area may be smaller compared to powder zinc, the discharge current may not be smaller to such an extend because particles can be covered with an oxide layer and electrical conduction through the oxides of the particles is lower compared to electrical conduction in the solid zinc layer described here.

One of the advantages of solid zinc, non-powdery deposition is high zinc utilization on discharge and the ability to deposit thick smooth layer of zinc of hundreds of mg/cm² and more. Further, virtually unlimited number of charge/discharge cycles without any permanent electrode shape change could be realized with such an electrode.

According to still another preferred embodiment, the current collector material is selected from the group comprising one or more of steel, low carbon steel, nickel, nickel plated steel, nickel plated low carbon steel, or nickel-phosphorus (NiP) covered steel. It was found that low carbon steel is a preferred material as for its very low price, not corroding in an alkaline environment and no H₂ is being evolved on its surface. The electrode may also comprise at least one of polymer substrates with nickel (Ni) or NiP surface coatings or composite materials. Or the electrode may comprise a structure made from carbon fibers or fibers with electrically conducting surface coatings. Optional additives to reduce self-discharge can be further applied to either the electrolyte or deposited on the current collector material. In that case, the surface of the electrode is increased, but a compact, high density, high conductivity zinc layer is deposited on such high surface area substrate.

Further, according to a preferred embodiment, the current collector material is cold formed, preferably cold rolled.

Further, according to another preferred embodiment, the current collector material is cold rolled steel, in particular cold rolled low carbon steel. Surprisingly, it has been found that cold-formed materials, in particular cold-formed or cold-rolled steel or low carbon steel, are particularly well suited as collector materials for producing the electrode according to the invention. It was found that cold rolled low carbon steel is a preferred material as for its very low price, not corroding in an alkaline environment, and no H₂ is being evolved on its surface at electrodeposition. It may be that these materials have a similar crystalline or microscopic surface to pure zinc, thus supporting the formation of a solid zinc layer. In this respect, it is surprising that the deposition of zinc on such a collector can be achieved without any additives and/or binders. Of course, additional additives or binders could be used, but it has been shown that these are not essential for the formation of the electrode according to the invention.

According to yet another preferred embodiment, the zinc layer is free of copper (Cu). It has been shown to be beneficial if no ions such as Cut are present during the deposition of the zinc. Such ions will promote H₂ evolution on charging, thereby causing mossy zinc deposition. If the presence of copper during deposition is avoided as far as possible, the zinc electrode plated with zinc is practically free of copper. However, it is also possible to use copper as a collector material. In this case, however, care must be taken to prevent the dissociation of Cut-ions during deposition in order to suppress H₂ evolution during deposition. Thus, a copper collector may be covered with a Ni, NiP, or other iron (Fe—) alloy coating.

According to yet another preferred embodiment, the zinc layer has a mass of 200 mg/cm², preferably of 300 mg/cm², and most preferably of 400 mg/cm². The zinc electrode according to the invention can have a zinc deposit of a mass of a few micrograms to several hundred or thousands of milligrams per square centimeter (mg/cm²). In principle, the mass of such a zinc layer according to the invention is almost infinite, but it is obvious that there are certain limits in the realization of such a layer. Until now, such layer masses of solid metallic zinc could not be produced within the state of the art. The zinc electrode according to the invention is therefore unique in terms of its compactness, morphology, and three-dimensionality. However, as said, it is also possible to achieve even higher layer masses, e.g., by continuously applying new zinc-comprising electrolyte during the electrodeposition in an application. With such an application even thousands of mg/cm² can be realized. In terms of capacitance per cm², such zinc layers of 200 to 400 mg/cm² according to the invention correspond to a capacity density of 164 to 328 mAh/cm². As mentioned, however, layer masses of more than a thousand mg/cm² can also be achieved, thereby allowing even higher capacitance densities to be obtained. It is also clear that the zinc layer mass to be achieved will be different for various applications and application types. For example, a battery application requires a less massive layer than a H₂ generator application.

According to yet another preferred embodiment, the zinc layer has a mass of 0-10000 mg/cm²; preferably of 1-5000 mg/cm²; and more preferably of 25-2000 mg/cm².

According to yet another preferred embodiment, the zinc layer has a mass of up to 10000 mg/cm²; preferably of up to 5000 mg/cm²; and more preferably of up to 2000 mg/cm².

According to yet another preferred embodiment the mass in mg/cm² of the zinc layer (300) is almost unlimited.

According to yet another preferred embodiment, the zinc layer has a mass of at least 25 mg/cm².

According to yet another preferred embodiment, the zinc layer has a porosity of less than 50%. The electrode according to the invention is very compact with a density range of the zinc deposit like that of the real density of metallic zinc, thus the zinc deposit also has a lower porosity of less than 50%. However, the porosity can be set even lower at up to 40%. A porosity of less than 30% is preferred, and less than 20% is particularly preferred. Conventional zinc electrodes do not achieve such low porosity values, not to speak of electrodes used in zinc-air batteries. Compared to common electrode surfaces, the specific active surface of the zinc electrode according to the invention is several 100 to 1000 orders of magnitude lower than the specific active surface in zinc-air battery applications due to the lower porosity. For example, the surface area of the zinc powder (e.g. in zinc-air batteries) according to the state of the art is about 1 m²/g. According to the invention, layers of a few micrograms to several thousands of milligrams per cm² can be achieved. With a layer mass according to the invention of, for example, 200 mg/cm², this would result in a surface area for the zinc powder case of approx. 2000 cm², which is a factor of 2000. Thus, even if a certain porosity is still present in the layer according to the invention, the active surface area is several orders of magnitude lower than that of a conventional electrode layer of the state of the art.

According to the invention an electrochemical cell is provided which comprises the zinc electrode according to one of the aforementioned zinc electrode embodiments for zinc electrodeposition, wherein the electrochemical cell further comprises a zinc-comprising electrolyte and a cathode.

In the sense of the invention, the current collector material of the zinc-electrode is also named negative electrode, anode, anode current collector material, or anode collector material. In the sense of the invention, the cathode is also named positive electrode, counter electrode, counter current collector material, cathode current collector, or cathode collector material.

To create a zinc loaded electrode with the electrochemical cell, the cell can be assembled in a discharged state (SOC=0) with only an anode current collector material as the negative side and a cathode current collector as the positive side, and both sides (negative, positive) are connected through an electrolyte which comprises zinc mainly in form of ZnO and/or zincate but not powdery zinc. However, in the sense of the invention, an electrochemical cell comprises an anode collector material, a cathode collector material and a suitable electrolyte. For the sake of the invention, electrochemical cell is defined as a generic term for various arrangements, either used in electrochemistry or based on electrochemical processes. In this context, electrochemical cell includes galvanic cell, electrolytic cell as well as accumulator cell. The electrolyte may be liquid or solid, or both liquid and solid electrolyte may be present. An electrochemical cell can thus be defined as an arrangement of two electrodes conductively connected via a zinc-comprising electrolyte.

According to a preferred embodiment of the electrochemical cell, the zinc-comprising electrolyte is alkaline. Although it is also feasible that the zinc-comprising electrolyte may mainly comprise zinc chloride or ammonium chloride, an alkaline environment is still preferred.

According to a preferred embodiment of the electrochemical cell, the zinc layer, the zinc-comprising electrolyte, the current collector material and/or the cathode is free of copper, copper ions and/or copper oxides.

According to another preferred embodiment of the electrochemical cell, the zinc-comprising electrolyte comprises a zinc-source which is selected from the group comprising one or more of Zn²⁺-ions, ZnO, zincate and/or a zinc-complex. When the present invention refers to a zinc-comprising source or zinc-comprising electrolyte, it primarily means one of the above-mentioned substances, with ZnO and zincate being preferred. For the purposes of the invention, zinc complexes are understood to be any kind of zincate complexes, but also those complexes which contain zinc and can dissociate during (re) charging so that solid Zn can be further deposited on the collector material or on the collector already plated with a zinc layer. The zinc source can have different viscosities and can be used as paste or slurry or as solution. It is also possible to use several of the zinc sources together. However, it should be expressly mentioned that in the sense of the invention, a zinc-comprising source or a zinc-comprising electrolyte does not comprise zinc in the form of powdery zinc. Rather, the use or application of powdery zinc in form of solid zinc powder is not suitable for the invention.

According to yet another preferred embodiment of the electrochemical cell, the zinc-source or at least one component of the zinc-source is supersaturated after the cell is discharged. This means that during the discharge of the cell, the components of the zinc source do not convert exactly stoichiometrically back into the components actually used at the beginning, but at least one component is not or cannot be converted any further, so that this component is present in a super-saturated concentration. For example, ZnO can be used which is transferred via zincate to zinc which is then plated during the electrodeposition. In the reverse reaction, i.e. the discharge process, zinc is transferred to zincate, but not all zincate above the saturation point is transferred back to ZnO, so that zincate is now supersaturated.

According to yet another preferred embodiment of the electrochemical cell, the alkaline zinc-comprising electrolyte comprises KOH. In this context, the electrolyte may further contain KOH with a minimum amount of 5-25 wt % and a maximum amount of 35-60 wt %, with an amount of 26 wt % to 36 wt % KOH being preferred and 30 wt % KOH being preferentially preferred.

According to yet another preferred embodiment, the zinc-comprising electrolyte further comprises NaOH with a minimum range of 5-15 wt % and a maximum range of 16-30 wt %, with 20 wt % NaOH being preferred and with 18 wt % NaOH being preferentially preferred. NaOH can be used in place of KOH or in combination as well.

According to still another preferred embodiment of the electrochemical cell, the zinc-comprising electrolyte, when it is applied to a new electrochemical cell, has a minimal ZnO/KOH-ratio of 190.00 g ZnO in 1 L KOH, wherein a minimal ZnO/KOH-ratio of 100.00 g ZnO in 1 L KOH being preferred, and a minimal ZnO/KOH-ratio of 8.00 g ZnO in 1 L KOH being preferentially preferred and/or wherein the zinc-comprising electrolyte has a maximal ZnO/KOH-ratio of 2380.00 g ZnO in 1 L KOH, wherein a maximal ZnO/KOH-ratio of 2670.00 g ZnO in 1 L KOH being preferred, and a maximal ZnO/KOH-ratio of 2980.00 g ZnO in 1 L KOH being preferentially preferred. At the end of the charge the concentration can be much lower, hence the minimal zincate or dissolved ZnO (as ZnO will not stay as ZnO anyway since it is below saturation point) is approximately at 0.1 M per 1 L KOH or 8 g ZnO per 1 L KOH. For the purposes of the invention, “applied to a new electrochemical cell” means that the cell is being loaded for the first time or with fully fresh electrolyte. The applied ratio is therefore the ratio which exists before a deposition process or charge cycle starts. It is understood that these parameters change during a charge or discharge cycle.

According to still another preferred embodiment of the electrochemical cell, the zinc-comprising electrolyte comprises a minimal ZnO concentration of 0.01 M per 1 L KOH in H₂O electrolyte, wherein a range between 0.1 and 0.8 M per 1 L KOH is preferred, and wherein a maximal concentration is between 0.8 M and 1.5 M per 1 L KOH is preferred.

According to still another preferred embodiment of the electrochemical cell, the ZnO/KOH-ratio is independent of the KOH concentration.

According to still another preferred embodiment of the electrochemical cell, the zinc-comprising electrolyte further comprises Pb, Fe, Sn, CdMg or other metals or alloys. It may also be that the electrolyte comprises hydroxide additions of at least one of In-, Pb- and/or Sn-hydroxide in concentrations of 10-500 ppm based on the amount of ZnO in the electrolyte. Such addition can increase the hydrogen overvoltage and thus reduce self-discharge of a cell. It is also possible that the electrolyte comprises additions of at least one of an electrolyte additives and/or a surfactant such as a polyoxyethylene octadecenyl ether phosphate, a polyethylene glycol, a copolymer with acidic groups, a solution of modified styrene maleic acid copolymer, a solution of an alkylolammonium salt of a lower molecular weight polycarboxylic acid polymer, phosphate esters of an alkylphenoxy polyethoxyethanol, a polyether phosphate ester or a solution of octylphenoxypolyethoxyethylphosphate, water, phosphoric acid and polyethylene glycol octylphenyl ether. Such additives that are also used in alkaline primary batteries to reduce self-discharge can also be used for the present invention, e.g. electrolyte additives and/or surfactants such as a polyoxyethylene octadecenyl ether phosphate, a polyethylene glycol, a copolymer with acidic groups, a solution of modified styrene maleic acid copolymer, a solution of an alkylolammonium salt of a lower molecular weight polycarboxylic acid polymer, a phosphate ester of an alkylphenoxy polyethoxyethanol, a polyether phosphate ester, a polyether phosphate ester or a solution of octylphenoxypolyethoxyethylphosphate, water, phosphoric acid and polyethylene glycol octylphenyl ether. Such additives influence zinc passivation and thus the discharge and self-discharge behavior of an electrochemical cell.

A method for zinc electrodeposition in an electrochemical cell according to one of the aforementioned embodiments is also provided, wherein the method comprises:
using the electrochemical cell;
applying 5%-80% duty cycle pulses of 0-30 Hz, preferably of 5-20 Hz, more preferably of 10 Hz for zinc deposition onto the current collector material until a predetermined state of charge, SOC, and/or a predetermined mass of the zinc-layer is reached;
applying pulses with a lower limit of about 0.01 Hz, preferably of about 0.05 Hz and more preferably of about 0.1 Hz and an upper limit of about 500 Hz, preferably of about 100 Hz and more preferably of about 50 Hz until reaching a duty cycle of ≤8%-1%, preferably of ≤5%-2%, more preferably of 5% and/or a predetermined minimum current density of ≤10 mA/cm², preferably of ≤8 mA/cm², and more preferably of ≤5 mA/cm²; and
ending the method.

According to another preferred embodiment of the method, the method applies pulses of about 0.01-500 Hz, preferably of about 5-50 Hz, more preferably of about 5-25 Hz and even more preferably of about 10 Hz.

According to another preferred embodiment of the method, the method comprises:
using the electrochemical cell;
applying 5%-80% duty cycle pulses of 0-30 Hz, preferably of 5-20 Hz, more preferably of 10 Hz for zinc deposition onto the current collector material until a predetermined state of charge, SOC, and/or a predetermined mass of the zinc-layer is reached;
applying pulses of 5-20 Hz and more preferably of 10 Hz until reaching a duty cycle of ≤8%-1%, preferably of ≤5%-2%, more preferably of 5% and/or a predetermined minimum current density of ≤10 mA/cm², preferably of ≤8 mA/cm², and more preferably of ≤5 mA/cm²; and
ending the method.

According to another preferred embodiment of the method, the method further comprises applying for the pulses a pulse current density in a range of 1-300 mA/cm², preferably in a range of 5-170 mA/cm², and more preferably in a range of 5-125 mA/cm².

The method parameters as duty cycle, frequency or current density can be optimized for charge time, charging efficiency and structure (meaning the deposition of a smooth solid zinc layer according to the invention). However, according to the invention low duty cycle (e.g. 5%) of 10 Hz together with a low current density (5 mA/cm²) will charge all ZnO/zincate concentrations for a massive layer of zinc deposition (tenths to thousand mg/cm²). However, the charge time is very long. To reduce charge time, higher current density is required. Two options for higher average current density can be applied: (a) low duty cycle high current density or (b) high duty cycle low current density, both of them, (a) and (b), with the same average current density. The low duty cycle high current density option (a) will have lower electrical efficiency, the high duty cycle low current density option (b) will have better electrical efficiency.

As an example, using saturated zincate in 30% KOH: (a) 40% duty cycle 80 mAh/cm² or (b) 80% duty cycle 40 mA/cm², both (a), (b) will plate <100 mg Zn/cm². However, the 40 mA/cm² option (b) will become mossy if deposition of zinc approx. >100 mg/cm². But if that is the thickness which is desired, 100 mg/cm² zinc deposited with option (b) will be more electrically efficient. Supersaturated zincate will require lower duty cycle lower current density until saturation point is reached and then 40 mA/cm² 80% duty cycle (option (a)) can be used. A combination can be used, starting with 40 mA/cm² 80% duty cycle (option (b)) and halfway switch to 40% duty cycle 80 mA/cm² (option (a)) and go beyond 100 mg/cm².

The parameters shown here are basic parameters with which a zinc electrode according to the invention can be obtained. However, it is understood that the pulsing parameters are for example impacted by zincate concentration (or other zinc-sources concentration), ZnO load meaning how thick/viscose the ZnO/KOH paste is applied. Further, it is also clear that these initial parameters will change during the deposition process, e.g. the charging progress, temperature, zinc load/cm². For the zinc deposition, 5% to 80% duty cycle pulses of 0-30 Hz, preferably of 5-20 Hz, more preferably of 10 Hz, up to the desired mass of the zinc deposition are applied for allowing the zincate ions to get close to the electrode surface and for the OH into the bulk and to avoid H₂-evolution. All pulses are suitable for suppressing H₂ generation in order to prevent the formation of mossy or dendritic zinc deposits.

There are some conditions which allow a metallic solid non-powdery and non-mossy deposition of zinc during charging of an anode current collector material (negative electrode) in an electrochemical cell. However, not all conditions must actually be present for a zinc electrode to be prepared according to the invention, in other words not all conditions are essential, but it is merely advantageous if they are present.

Optionally, there should be no ions such as Cut in the cell, such ions will promote H₂ evolution on charging causing mossy zinc deposition.

Moreover, no copper oxides or passivation on the surface of the current collector should be present, since such oxides could otherwise promote H₂ evolution on charging causing mossy zinc deposition.

Deposition parameters can be chosen in a way that no H₂ be evolved. H₂ bubbles causes zinc deposition around them, making mossy zinc. Actually high currents will cause H₂ evolution. The use of high current density will have a benefit primarily at the beginning of the deposition, depending on the substrate (current collector material or already deposited Zn layer). However, the pulsing is what eliminates the H₂ bubbles in the first place, not the high current densities. If depositing on a substrate made of material having a low H₂ overpotential, meaning it is a good H₂ evolving substrate or catalyst, then initial high current pulsing of 40 mA/cm² and up for a duration of tenths of seconds is required to get an initial plating that blocks the activity of the catalytic nature of the substrate. Further, it is also beneficial to increase the number of nucleation sites on such substrates. Otherwise, the substrate will dissolve the deposition as it is being deposited. After the initial deposition, the currents should be reduced, otherwise mossy Zn will evolve.

The current collector material should be selected to have high H₂ overpotential to avoid H₂ evolution, so that when plating starts on bare current collector material no H₂ should be evolved.

Another important condition is time. Thus, time should be allowed for the consumed zincate ions to be replenished on the interface layer of the electrode/electrolyte. This is achieved by lowering the duty cycle, for example, if very thick ZnO paste (thick in the sense of the invention meaning here high viscose, high ZnO concentrated according to the other mentioned embodiments of the invention) that is located between Zn electrode and separator requires low duty cycle such as 10% but lower ZnO or zincate concentrations allows 80% duty cycle. However, as zincate is being depleted towards the end of charge, lower duty cycle should be applied.

According to another embodiment of the method, the method further comprises applying 5%-80% duty cycle pulses of 0-30 Hz, preferably 5-20 Hz and more preferably 10 Hz with a current density ≥40 mA/cm². This first Zn deposition step is performed prior to the main zinc depositing step. For a current collector material with low H₂-overpotential, such as nickel, such a step is essential, since it prevents H₂-evolution, which could otherwise occur during a zinc deposition with the parameters described in the method according to the invention. In addition, with this step, the number of nucleation sites can be increased, which benefits a more uniform and improved zinc deposition in the next step. This increase in the number of nucleation sites is true for a material with high H₂-overpotential as well as for materials with low H₂-overpotential, such as cold rolled low carbon steel. However, in case of cold rolled low carbon steel, such a step is not essential. Preferably, such a step is applied in the method of the invention when a bare current collector is present, i.e. when the method for zinc deposition in an electrochemical cell is applied for the first time with a bare current collector material or when the zinc layer has been completely detached from the current collector material by a previous discharge cycle or step.

According to another embodiment of the method, the method further comprises applying 5%-10% duty cycle pulses of 1-100 kHz, preferably of 30-70 kHz, more preferably of 50 KHz for s seconds to m minutes in the case the electrochemical cell was partially or completely discharged before and passivation has been formed on the surface. Passivation on the surface should be detached prior to zinc deposition. Otherwise, plating on passivation will cause a mossy zinc deposition. However, passivation will be eventually dissolved when the zincate concentration gets low. Detaching the passivation is done by pulsing low duty cycle pulses of tenths of microseconds (μs) for a few seconds (e.g., 1 to 90 seconds, preferably 5-50 seconds, more preferred 30 seconds) to a few minutes at the beginning of the charging or deposition.

According to another embodiment of the method, the method further comprises monitoring the zinc-electrodeposition upon a spike in cell current and/or a drop in cell voltage, and if either a spike and/or a drop is present, immediately stopping the zinc-electrodeposition and ending the method. Such a spike and/or drop indicates a short which means that the zinc-deposition is probably mossy or dendritic. Such unwanted depositions are recovered by complete or partial discharge of the electrochemical cell meaning complete or partial removal of the zinc-layer. After this, a new zinc-deposition can be started (e.g. at SOC=0, if fully discharged).

According to another embodiment of the method, the method further comprises monitoring the zinc-electrodeposition upon a predetermined cell current limit and/or a predetermined cell voltage limit, indicating a predetermined state of charge (SOC) and if the predetermined SOC is reached, applying pulses of 5-20 Hz and more preferably of 10 Hz until reaching a duty cycle of ≤8%-1%, preferably ≤5%-2%, more preferably of 5% and/or a predetermined minimum current density of ≤10 m A/cm², preferably of ≤8 mA/cm², and more preferably of ≤5 mA/cm².

The parameters used to monitor the zinc electrodeposition can also vary depending on whether a special cell design is required or whether additional temperature control is required. Also, the parameters for the different states of charge can be fixed, or these can be dynamically adjusted by doing occasional fast impedance spectroscopy (EIS) during the charging, adjusting pulsing parameters accordingly for the purpose of expediting charging while avoiding shorts.

On the fly fast electrochemical impedance spectroscopy (EIS) can be done to get information on the condition of the cell and charging status. As an example, roughness of the surface can be indicated by EIS, high roughness will indicate mossy buildup, which is bad, low roughness indicates solid Zn buildup. EIS can be done before charging is started and shortly after and once every x time, indicating the presence of passivation, if the charging starts properly and if the Zn buildup maintains good Zn solid structure. Surface roughness is indicated by the electrochemical double-layer capacity. The higher the capacitance compared to the bare current collector capacity, the higher the surface area which means mossy plating buildup. The measurement can be done at several frequencies but doesn't need to be a continuous frequency scan. As long as the zinc buildup stays solid non-mossy with relatively low roughness, capacitance will stay quite similar to the bare current collector's capacity.

Further, the amount of electrolyte or amount of zincate and/or ZnO in the cell can be determined by the cell resistance (the real component of the impedance), which can be achieved by low frequency measurements. Further, passivation can be detected by EIS.

In a different scenario, if the zinc electrode is part of an electrochemical cell that includes a catalyst gas evolving electrode that produces oxygen during zinc deposition and H₂ during zinc dissolution, a recombination catalyst that is used as a safety device can also be used as a sensor. The recombination catalyst temperature can be monitored for out-of-control zinc buildup and for end of charge. In both cases H₂ will start evolving and since O₂ is present, the recombination catalyst temperature will start rising indicating that charging should be terminated. The same will happen in discharge conditions. If the recombination catalyst temperature rises, this is a hint that a cell reversed its polarity end electrolyzing, releasing O₂ and H₂ at the same time, thus discharge should be terminated.

Further, in another case of rechargeable zinc batteries, oxygen may evolve on the positive electrode in case of overcharge or hydrogen can evolve on the negative electrode depending which electrode has less active material. A gas passage can be implemented in the cell that the oxygen can recombine with hydrogen at a recombination catalyst or react with the zinc minus pole.

But it is also possible that the duty cycle is adapted to the already charged capacity and thus to the thickness of a zinc layer on the electrode and the ZnO/zincate concentration during charging. In general, the duty cycle can be increased during charging. For each type and size of electrochemical cell, the required charging parameter, duty cycle, can be determined as a function of current, state of charge, and temperature. This can be stored in a look-up table, which can then be used for discharging.

An electrochemical cell is also provided. Embodiments of the electrochemical cell can be utilized in embodiments of the method as well.

The following methods, which are known to the person skilled in the art, can be used to determine the properties and/or parameters of the zinc electrode according to the invention as well as to the embodiments described therein:

Since the zinc layer is a solid metal with only some surface roughness and almost no intrinsic voids or closed pores, a microscopic image is sufficient to determine the structure.

The structure of the zinc layer can therefore be analyzed using microscopic images taken by optical or electron microscope, e.g. a Scanning Electron Microscope (SEM). The result can be quantified by computational image analysis.

Scanning Electron Microscopy (SEM) is a technique for imaging the surface morphology of materials at high magnification. It provides detailed three-dimensional images and can be used to identify features such as cracks, pores, and grain boundaries in metal coatings.

Alternatively, or additionally, other methods such as TEM or AFM can also be used. Transmission Electron Microscopy (TEM) generally offers even higher magnification than SEM and is capable of providing detailed information about the internal structure of the coating, including nanoscale features. Atomic Force Microscopy (AFM) is a high-resolution imaging technique that uses a sharp tip to scan the surface of a sample. It is particularly useful for studying surface roughness and can provide information about both the topography and mechanical properties of the coating.

The zinc layer can also be analyzed by using laser confocal microscopy, which directly provides the roughness values, and which was used to calculate the volume below the surface.

X-ray Diffraction (XRD) can be used to analyze the crystalline structure of coatings and provides information about the crystallographic phases present in the coating, grain size, and preferred orientation of crystals.

Various porosimetry techniques, such as mercury intrusion porosimetry or gas adsorption (e.g., BET method), can be employed to determine the porosity of a coating. These methods help to quantify the volume and size distribution of pores within the coating.

Cross-sectional analysis involves preparing a sample with a known coating and then cutting it to expose the internal structure. This allows direct observation of the coating-substrate interface and assessment of porosity and thickness. A more advanced technique uses an ion beam to prepare a cross section (focused ion beam, FIB).

Electrochemical Impedance Spectroscopy (EIS) can be used to evaluate the corrosion resistance of a metal coating and indirectly infer information about its porosity. Changes in impedance can provide insights into the coating's ability to resist corrosive attacks.

Microhardness tests, such as Vickers or Knoop hardness tests, can be performed on cross-sections of coated samples. Variations in hardness across the coating may indicate differences in porosity or composition. Mossy layers are very soft compared to solid or bolder like zinc.

Since the zinc electrode is mostly solid, has a relatively rough surface and is deposited on a substrate of known weight and area, only the thickness of the zinc layer needs to be measured to determine the Zn density.

In general, the following methods are known by the skilled in the art to determine the density of the zinc layer:

Archimedes' Principle method involves immersing the porous metal sample in a fluid (typically a liquid) and measuring the displacement of the fluid. According to Archimedes' principle, the buoyant force acting on a submerged object is equal to the weight of the fluid it displaces. The density of the material can then be calculated based on the known density of the fluid.

Gas pycnometry is a technique where a gas is used to determine the volume of the pores in the material. By knowing the volume and mass of the sample, the density can be calculated.

X-ray Computed Tomography (CT) can provide a three-dimensional image of the internal structure of the porous metal. By analyzing the CT scans, researchers can estimate the volume of the solid material and void spaces. This information, combined with the mass of the sample, allows the calculation of density.

Ultrasound techniques can be used to measure the velocity of sound waves passing through the material. The density can be inferred from the speed of sound and the known acoustic properties of the material.

Optical and/or electron microscopy combined with image analysis software can be employed to analyze the microstructure of the porous metal. By quantifying the amount of solid material and void spaces, researchers can estimate the overall density.

In the helium displacement method, helium is used to displace air within the pores of the material. The change in pressure or volume is then measured, and the density is calculated based on the ideal gas law.

Similar to Archimedes' principle, the Buoyancy methods involve immersing the sample in a liquid. However, instead of measuring the displaced fluid, buoyancy methods may directly measure the force exerted on the sample due to buoyancy.

The mass of the zinc layer can be determined using the gravimetric method. The gravimetric method is based on the fact that zinc is deposited on a current collector. The weight of the current collector is measured before the deposition starts. After the zinc is deposited, the weight is measured again and the difference is the weight of the zinc coating.

The following well-known methods can also be used to determine the mass of the zinc layer:

Quartz Crystal Microbalance (QCM) is a highly sensitive mass measuring device that uses the change in resonance frequency of a quartz crystal due to added mass. As the coating is deposited on the crystal, it causes a shift in the resonance frequency, allowing for precise measurement of the added mass.

Coulometric method measures the quantity of electricity passed during the deposition process. By knowing the electrochemical equivalent of the metal being deposited, one can calculate the mass of the coating.

In the Beta Backscatter method, beta particles are directed at the coated surface and the backscattered radiation is measured. The intensity of the backscattered radiation is proportional to the coating thickness.

X-ray Fluorescence (XRF) beta particles are directed at the coated surface, and the backscattered radiation is measured. The intensity of the backscattered radiation is proportional to the coating thickness.

Neutron Activation Analysis (NAA) involves irradiating the coated sample with neutrons and then measuring the gamma rays emitted. The intensity of the gamma rays is proportional to the amount of the specific metal in the coating.

In general, all these methods belongs to the skilled person's common general knowledge. Further, the skilled person can use all known methods to determine the parameters and/or properties of a zinc electrode and is not limited to the methods described in this description.

In addition, all the methodologies known in the relevant technical field for determining the parameters and/or properties yield the same result within the appropriate limit of measurement accuracy.

It has also to be noted that aspects or embodiments of the invention have been described with reference to different subject-matters. In particular, some aspects or embodiments have been described with reference to apparatus type claims whereas other aspects have been described with reference to method type claims. However, a person skilled in the art will gather from the above and the following description that, unless otherwise notified, in addition to any combination between features belonging to one type of subject-matter, also any combination between features relating to different types of subject-matters is considered to be disclosed with this text. In particular combinations between features relating to the apparatus type claims and features relating to the method type claims are considered to be disclosed. The invention and embodiments thereof will be described below in further detail in connection with the drawing(s).

Other details, objects, and advantages of embodiments of the cell, cell system, and methods of making and using the same will become apparent as the following description of certain exemplary embodiments thereof proceeds.

### BRIEF DESCRIPTION OF THE DRAWINGS

The invention and embodiments thereof will be described below in further detail in connection with the drawing(s). The drawings and schematic illustrations, unless otherwise described, are not to scale and are mainly used to visually describe the embodiment examples.

FIG. 1 shows an image of a surface of a zinc deposit with heavy spongy micromorphology according to the state of the art adapted from R. Y. Wang et al., Journal of The Electrochemical Society, 153 (5) C357-C364 (2006).

FIG. 2 shows an image of a surface of a zinc deposit with dendritic micromorphology according to the state of the art, adapted from R. Y. Wang et al., Journal of The Electrochemical Society, 153 (5) C357-C364 (2006).

FIG. 3 shows an image of a surface of a zinc deposit with mossy micromorphology according to the state of the art, adapted from R. Y. Wang et al., Journal of The Electrochemical Society, 153 (5) C357-C364 (2006).

FIG. 4 shows an image of a surface of a zinc deposit with boulder micromorphology according to the state of the art, adapted from R. Y. Wang et al., Journal of The Electrochemical Society, 153 (5) C357-C364 (2006).

FIG. 5 shows an image of a surface of a zinc deposit with layerlike micromorphology according to the state of the art, adapted from R. Y. Wang et al., Journal of The Electrochemical Society, 153 (5) C357-C364 (2006).

FIG. 6 shows a table of a categorization of Zn deposits according to the state of the art, adapted from R. Y. Wang et al., Journal of The Electrochemical Society, 153 (5) C357-C364 (2006).

FIG. 7 shows a schematic illustration of an anode electrode electrodeposited with zinc developing a dendritic morphology according to the state of the art.

FIG. 8 shows a schematic illustration of an anode electrode electrodeposited with zinc developing a filamentous/mossy morphology according to the state of the art.

FIG. 9 shows a schematic illustration of an anode electrode electrodeposited with zinc developing a solid metallic (layerlike) morphology according to an embodiment of the invention.

FIG. 10 shows a flow chart of method steps according to one embodiment of the invention for producing a zinc electrode as described in the present invention in an electrochemical cell.

Reference numerals used in the drawings include:
100 zinc electrode
200 current collector material
300 zinc layer
310 dendritic zinc layer surface
311 detached dendrites
320 mossy zinc layer surface
321 detached mossy zinc
330 solid metallic zinc layer surface (layerlike)
S100-S500 method steps S100 to S500

### DETAILED DESCRIPTION

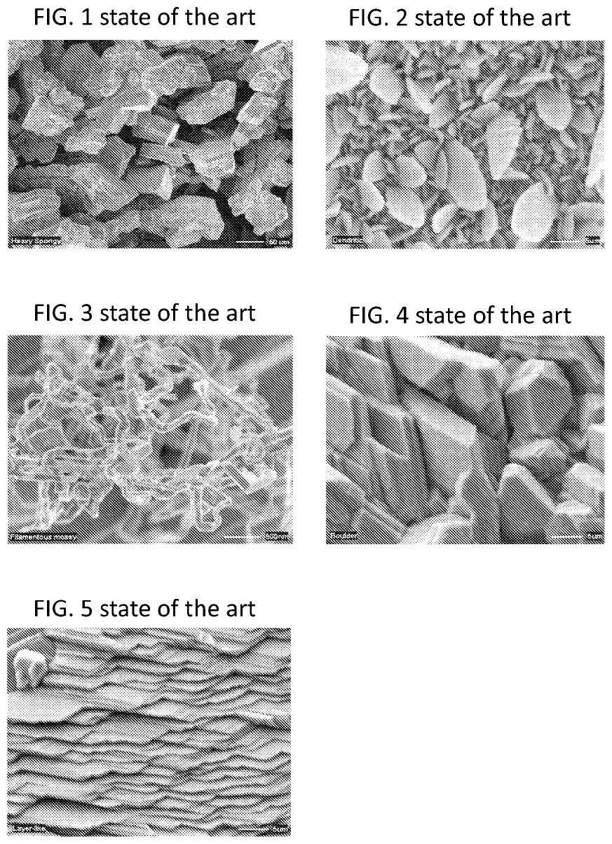

FIG. 1 shows an image of a surface of a zinc deposit with heavy spongy micromorphology. As can be seen, heavy spongy deposits are large boulder agglomerates and highly branched dendrites, developing at very high current density (cd) and after long deposition time. Further, such deposits have a fine dispersed porosity and an anisotropically orientated crystallinity. Depending on their appearance, such deposits can be perceived by the human eye primarily as a blackish powder. However, such heavy spongy deposits are nonadherent, which leads to these layers crumbling away or parts of the layer detaching easily, e.g. in the event of minor vibrations or spontaneously.

FIG. 2 shows an image of a surface of a zinc deposit with dendritic micromorphology. Dendrites are treelike, leaf or fern structures and can be hexagonal if deposition is slow. The porosity of such deposits is dispersed, and they possess an isotopically orientated crystallinity. Depending on their appearance, such deposits can be recognized as metallic crystalline by the human eye. However, such deposits are nonadherent and can break easily depending on their structure. Another reason that makes such deposits unsuitable for some types of applications is that the spikes of the dendrites can penetrate or damage separators. Dendrites are mainly formed at a very high current density.

FIG. 3 shows an image of a surface of a zinc deposit with mossy micromorphology. Filamentous mossy deposits have the appearance of tangled whiskers with a typical diameter of 50-200 nm and lengths that can exceed 5 μm. Like dendrites and heavy spongy deposits, mossy deposits are also nonadherent. However, they have an extremely high porosity and an isotropically oriented crystallinity. They can primarily form at low current densities. Like heavy spongy deposits, they are primarily visible to the human eye as a blackish powdery layer. These mossy deposits tend to detach or break off, as can be anticipated from FIG. 3. When such a mossy deposit detaches from the electrode or zn deposited layer, these mossy filaments appear as cloud-like structures in the middle of an electrochemical cell between the two electrodes without being connected to them.

Further, FIG. 4 shows an image of a surface of a zinc deposit with boulder micromorphology. Boulders are typically hexagonal shape in discrete assemblies. Layer-by-layer growth on individual boulder deposits can be seen from FIG. 4. Boulder deposits have a granular boulder-like shape and possess mainly an anisotropically orientated crystallinity. Unlike the other aforementioned deposits, these deposits possess a very compact porosity which means they are mainly nonporous. Further, these deposits are adherend meaning that it is atypical and rare for parts of this layer to detach. To the human eye, such a boulder-like deposit appears as a greyish metal. It is assumed that such deposits can occur at a medium or moderate current density.

FIG. 5 shows an image of a surface of a zinc deposit with layerlike micromorphology. Layerlike deposits are of epitaxial growth and are typically found at the beginning of deposition. This type of Zn-deposit is probably the most compact and has almost no porosity. It is visible to the human eye as a shiny metal layer and has a ridge-like or layer-like microstructure with epitaxially oriented crystallinity. This deposit is highly adherent and detachment of parts of this layer is only possible with considerable force, so that under normal circumstances spontaneous detachment of parts of the layer does not occur. Occurrence of this layer has been observed mainly at low current densities. It is interesting, however, that although this layer often appears at the beginning of depositions, it has not been possible in the prior art to realize such a layer-like deposit over a longer deposition time or over a certain thickness of the layer. With all processes described in the prior art and Zn electrodes shown therein, a layer-like Zn deposit of a larger thickness could be shown so far. The only methods or electrodes that have shown such a layer-like deposit with the properties described here have used pure or treated zinc as the collector material. However, this makes no sense at all for commercial applications, since, for example, when such an electrode is used in a battery, it completely disappears during discharge.

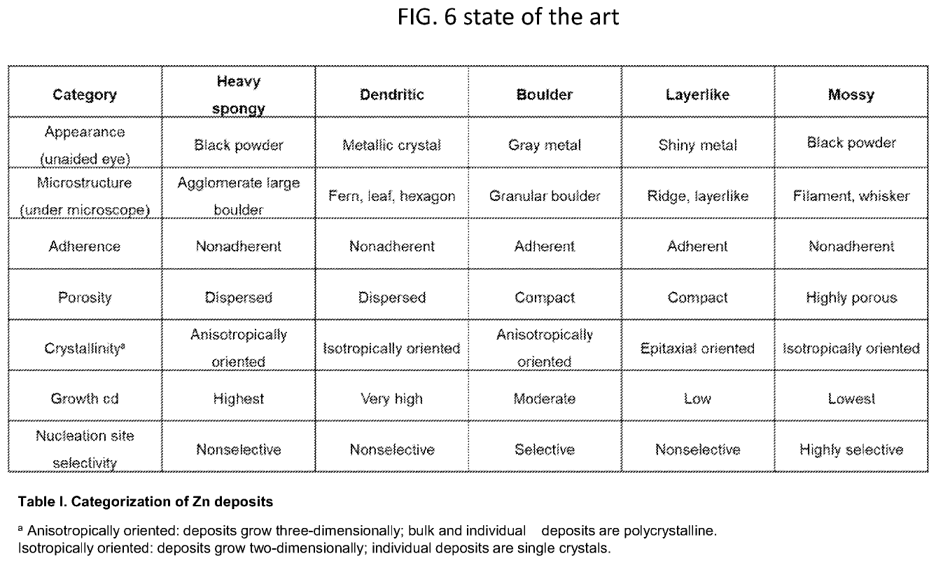

In FIG. 6 a table is depicted of a categorization of Zn deposits according to the state of the art. As can be seen from the table, various properties such as appearance with unaided eye, microstructure (under microscope), adherence, porosity, crystallinity, or growth current density can be assigned to the individual Zn-deposits.

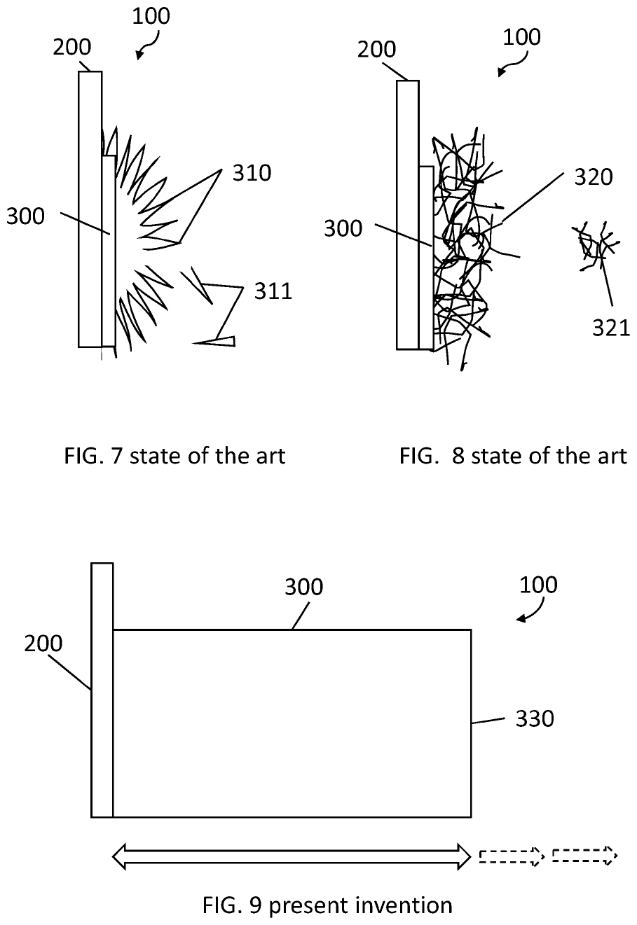

In FIG. 7 a schematic illustration is shown of a zinc electrode 100 with electrodeposited zinc developing a dendritic morphology 310. As shown in this figure, Zn is deposited on an anode current collector material 200 during electrodeposition. Initially, the Zn layer 300 is still very homogeneous, but with increasing layer thickness or duration of the electrodeposition, a shape change of the Zn layer begins. This now forms dendrites, which can break off or damage other components of an electrical cell such as a separator. Short circuits can also occur due to the detaching dendrite parts. The formation of such a dendrite layer can have several causes. One reason which was identified to have a huge impact on dendrite formation is the application of a very high current capacity during deposition.

Further, in FIG. 8 a schematic illustration is shown of a zinc electrode 100 with electrodeposited zinc developing a mossy morphology 320. FIG. 8 shows that after the initial compact deposition of zinc (zinc layer 300) on an anode collector material 200, a shape change occurs. The following deposit has a filamentous or mossy structure 320. This, as well as the structures of dendritic zinc or other non-compact structures like heavy spongy zinc, show a poor adherence to the substrate. These mossy zinc deposits can easily detach from the already deposited zinc or the collector material. These detached mossy Zn-deposits are usually visible as whitish, cloudy structures in the center, i.e. between the electrodes, of an electrochemical cell, sometimes with the naked eye. For example, flowing electrolyte can easily mechanically detach these mossy zinc deposits, which would result in capacity loss or blockage of the electrolyte in a flow application. Mossy zinc morphologies can occur due to very low current capacities during electrodeposition. Also, gas generation, mostly due to hydrogen gas generated during electrodeposition, can favor the formation of mossy zinc deposits.

FIG. 9 shows a schematic illustration of an anode electrode 100 electrodeposited with zinc developing a solid metallic (layerlike) morphology according to an embodiment of the invention. FIG. 9 shows an enormous deposit of a solid metallic zinc layer 300 directly on a collector material 200 of an anode electrode 100. This metallic zinc layer 300 has a layerlike and/or boulderlike morphology and exhibits a high density very close to that of pure metallic zinc. The layer 300 is compact throughout, and adheres firmly to the substrate and possesses a smooth surface 330. This compact layer 300 has almost no porosity. To the eye, the layer surface 330 appears greyish/shiny metallic or metallic shiny. The electrode 100 according to the invention can have layer thicknesses of well over 200 mg/cm² plated zinc.

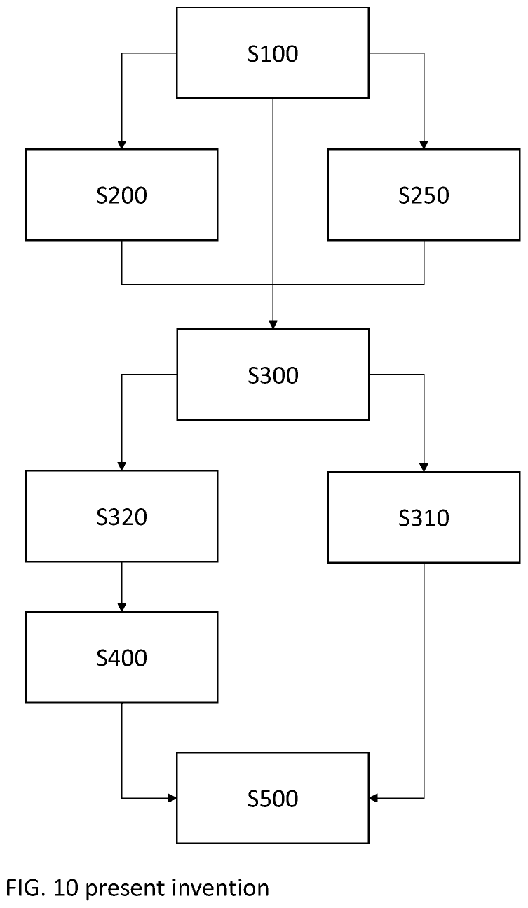

FIG. 10 shows a flow chart of a method according to one embodiment of the invention for producing a zinc electrode as described in the present invention in an electrochemical cell. An electrochemical cell comprises an anode collector material, a cathode collector material and a suitable electrolyte. For the sake of the invention, electrochemical cell is defined as a generic term for various arrangements either used in electrochemistry or based on electrochemical processes. In this context, electrochemical cell includes galvanic cell, electrolytic cell as well as accumulator cell. An electrochemical cell contains at least two electrodes or collector source materials, which always act as electron conductors, and at least one electrolyte, i.e. an ion conductor. The electrolyte may be liquid or solid, having a certain viscosity. An electrochemical cell can thus be defined as an arrangement of two electrodes conductively connected via a zinc-comprising electrolyte.

In a first step S100, a cell is provided having a zinc-comprising electrolyte, an anode collector material, and a cathode collector material. It is understood that the cell is designed so that the two collector materials (which can also already be described as starting electrodes) are conductively connected via a zinc-comprising electrolyte. This also encompasses all components such as housing, current source, voltage source, other measuring devices, etc.

Further, an optional step S200 can be implemented, in the case the deposition is done for the first time and/or a completely discharged current collector material having no zinc layer on it is used, and, additionally, the current collector has a low H₂-overpotential. Then, this step is mandatory to suppress the H₂-evolution at the current collector material in a further zinc deposition step (see S300), in other words, to block the catalytic activity of this current collector substrate. Also, this step is beneficial to increase the nucleation sides on the substrate to enhance layer formation. This step S200 is carried out by, for example, applying 5%-80% duty cycle pulses of 0-30 Hz, preferably 5-20 Hz and more preferably 10 Hz with a high current density ≥40 mA/cm².

Another optional step S250 can be applied, comprising 5%-10% duty cycle pulses of tenths of μs of 1-100 KHz for s seconds to m minutes (e.g., preferred≤30 seconds) at the beginning of the zinc deposition process. This step is beneficial to detach some passivation which may have occurred during a previous discharging of the cell or if the cell was stored in a semi discharged state for a longer period, since plating on passivation leads to mossy zinc deposition.

However, then, in step S300 the actual zinc deposition takes place. If a new cell with fresh electrolyte and a bare current collector with a high H₂-overpotential is available, the zinc deposition can be started immediately in step S300. In all other cases, step S200 and/or S250 must take place before step S300. In step S300, 5%-80% duty cycle pulses of 1-30 Hz, preferably of 5-20 Hz, more preferably of 10 Hz are applied for zinc deposition. This step is carried out until a predetermined mass of the zinc deposition has been reached or the zinc deposition has been stopped for other reasons like a predetermined charging stop or in rare cases the occurrence of a circuit short. The duty cycle depends on the amount of the zinc source, in most cases this is ZnO and/or zincate. As the zinc layer is depleted and the zincate level gets low, the duty cycle and current density is reduced (see step S400).

In case of interruption of the charging at any step as well as storing the charged cell and start further charging, step S250 can be implemented again. It comprises 5%-10% duty cycle pulses of tenths of μs of 1-100 KHz for s seconds to m minutes (e.g., preferred ≤30 seconds) at the beginning of the new zinc deposition process. This step is beneficial to detach some passivation which may have occurred during a previous discharging of the cell or if the cell was stored in a semi discharged state for a longer period, since plating on passivation leads to mossy zinc deposition.

In optional steps S310 and/or S320, the cell can also be monitored and inspected during zinc deposition. This can be done continuously or at intervals. If a drop in voltage and/or a rise in current (a short circuit) occurs during zinc electrodeposition, the deposition process is stopped (see step S500), since a mossy deposition of zinc has very likely occurred (S310). In such a case the cell should be discharged and then, after a passivation detaching step, (S250) a new deposition can start. However, if “no short circuit” means no mossy deposition occurs, monitoring can also track the desired predetermined charge status, or the state of charge (SOC) using current/voltage parameters and stop at the desired predetermined zinc layer mass (S320).

Subsequently, in step S400, pulses of 5-20 Hz, more preferably of 10 Hz are applied until reaching a duty cycle of ≤8%-1%, preferably of ≤5%-≤2% and/or a predetermined minimum current density of ≤10 mA/cm², preferably of ≤8 mA/cm², and more preferably of ≤5 mA/cm².

After that step, or in case a circuit short occurs, the zinc deposition is terminated (S500). The cell could now be discharged again.

It is also possible to remove the zinc loaded electrode from the cell for storage or transportation purposes. In the event of a short circuit, the cell should be fully discharged, and a new deposition process should be started to achieve zinc deposition in accordance with the invention.

It should be noted that the term “comprising” does not exclude other elements or steps and the “a” or “an” does not exclude a plurality. Further, elements described in association with different embodiments may be combined.

It should also be noted that reference signs in the claims shall not be construed as limiting the scope of the claims.

It is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of our process, apparatus, system, and methods of making and using the same have been shown and described above, it is to be distinctly understood that the invention is not limited thereto but may be otherwise variously embodied and practiced within the scope of the following claims.

1.-27. (canceled)

28. A zinc electrode, comprising:
a current collector material on which a zinc layer is electrodeposited, wherein the zinc layer appears as compact solid metal, comprises a boulder-like and/or layerlike microstructure and is adherent with a compact porosity;
the zinc electrode being obtainable by a method comprising:
using the electrochemical cell;
applying 5%-80% duty cycle pulses of 5-20 Hz for zinc deposition onto the current collector material until a predetermined state of charge (SOC) and/or a predetermined mass of the zinc-layer is reached; and
applying pulses with a lower limit of about 0.01 Hz and an upper limit of about 500 Hz until reaching a duty cycle of ≤8%-1% and/or a predetermined minimum current density of ≤10 mA/cm².

29. The zinc electrode according to claim 28, wherein the zinc layer is partially or completely removed from the current collector material during a discharge cycle resulting in a bare current collector material in case of a complete removal.

30. The zinc electrode according to claim 28, wherein the zinc layer is electrodeposited on a bare current collector material or on a current collector material on which a zinc layer is already electrodeposited.

31. The zinc electrode of claim 28, wherein the zinc layer comprises a density of 3.50-7.14 g/cm³.

32. The zinc electrode of claim 28, wherein neither the current collector material nor the zinc layer comprises a binder, a grid, a foam, a fabric structure, or an additive to couple the zinc layer to the current collector material.

33. The zinc electrode of claim 28, wherein the zinc layer is made from non-powder zinc.

34. The zinc electrode of claim 28, wherein the current collector material is selected from the group comprising one or more of steel, low carbon steel, nickel, nickel plated steel, nickel plated low carbon steel, or NiP covered steel.

35. The zinc electrode of claim 28, wherein the current collector material is cold formed, or cold rolled.

36. The zinc electrode (of claim 28, wherein the zinc layer comprises electrolyte and the current collector material and/or a cathode is free of copper, copper ions and/or copper oxides.

37. The zinc electrode of claim 28, wherein the zinc layer has a mass of up to 10000 mg/cm².

38. The zinc electrode of claim 28, wherein the zinc layer has a mass of at least 25 mg/cm².

39. The zinc electrode of claim 28, wherein the zinc layer has a porosity of less than 50%.

40. An electrochemical cell comprising a zinc electrode of claim 28 for zinc electrodeposition, the electrochemical cell further comprising:
a zinc-comprising electrolyte, and
a cathode.

41. The electrochemical cell according to claim 40, wherein the zinc-comprising electrolyte is alkaline.

42. The electrochemical cell according to claim 40, wherein the zinc-comprising electrolyte and/or a current collector material and/or the cathode is free of copper.

43. The electrochemical cell according to claim 40, wherein the zinc-comprising electrolyte comprises a zinc-source being selected from the group comprising one or more of Zn²⁺-ions, ZnO, zincate, or zinc-complexes.

44. The electrochemical cell according to claim 43, wherein the zinc-source or at least one component of the zinc-source is supersaturated after the cell is discharged.

45. The electrochemical cell according to claim 40, wherein the zinc-comprising electrolyte comprises KOH.

46. The electrochemical cell according to claim 40, wherein the zinc-comprising electrolyte, when it is applied to a new electrochemical cell, has a minimal ZnO/KOH-ratio of 190.00 g ZnO in 1 L KOH and/or wherein the zinc-comprising electrolyte has a maximal ZnO/KOH-ratio of 2380.00 g ZnO in 1 L KOH.

47. The electrochemical cell according to claim 40, wherein the zinc-comprising electrolyte comprises a minimal ZnO concentration of 0.01 M per 1 L KOH in H₂O electrolyte.

48. The electrochemical cell according to claim 47, wherein the ZnO/KOH-ratio is independent of the KOH concentration.

49. A method for zinc electrodeposition in an electrochemical cell, wherein the method comprises:
using the electrochemical cell;
applying 5%-80% duty cycle pulses of 5-20 Hz for zinc deposition onto the current collector material until a predetermined state of charge (SOC) and/or a predetermined mass of the zinc-layer is reached;
applying pulses with a lower limit of about 0.01 Hz and an upper limit of about 500 Hz until reaching a duty cycle of ≤8%-1% and/or a predetermined minimum current density of ≤10 mA/cm²; and
ending the method.

50. The method for producing a zinc electrode according to claim 49, wherein the method further comprises applying for the pulses a pulse current density of 1-300 mA/cm².

51. The method for producing a zinc electrode according to the claim 49, comprising:
applying 5%-80% duty cycle pulses of 0-30 Hz, with a current density ≥40 mA/cm² before the applying 5%-80% duty cycle pulses of 5-20 Hz for the zinc deposition onto the current collector material.

52. The method for producing a zinc electrode according to any of the claim 49, further comprising:
applying 5%-10% duty cycle pulses of 1 kHz-100 kHz for s seconds to m minutes after the electrochemical cell was partially or completely discharged, the applying of the 5%-10% duty cycle pulses of 1 kHz-100 kHz for s seconds to m minutes occurring before the applying of the 5%-80% duty cycle pulses of 5-20 Hz for the zinc deposition onto the current collector material.

53. The method for producing a zinc electrode according to claim 49, further comprising:
monitoring the zinc-electrodeposition upon a spike in cell current and/or a drop in cell voltage, and if either a spike and/or a drop is present, immediately stopping the zinc-electrodeposition and ending method.

54. The method for producing a zinc electrode according to claim 49, wherein the method further comprises monitoring the zinc-electrodeposition upon a predetermined cell current limit and/or a predetermined cell voltage limit indicating the predetermined SOC.

55. The method for producing a zinc electrode according to claim 49, wherein the method comprises:
applying pulses of 5-20 Hz until reaching a duty cycle of ≤8%-1% and/or a predetermined minimum current density of ≤10 mA/cm².
